(19) United States
(12) Patent Application Publication
(10) Pub. No.: US 2006/0168536 A1
(43) Pub. Date: Jul. 27, 2006

(54) Method and terminal for generating uniform device-independent graphical user interfaces

(75) Inventor: Jurg Portmann, Bach SZ (CH)

Correspondence Address: OLIFF & BERRIDGE, PLC, P.O. BOX 19928, ALEXANDRIA, VA, 22320, US

(73) Assignee: Swiss Reinsurance Company, Zurich (CH)

(21) Appl. No.: 10/559,568

(22) PCT Filed: May 12, 2004
(86) PCT No.: PCT/EP04/50776

§ 371 Date: Dec. 5, 2005

(30) Foreign Application Priority Data
Jun. 5, 2003 (EP) 03012822.7

(51) Int. Cl. G06F 3/00

(52) U.S. Cl. 715/762

(57) ABSTRACT

The invention relates to a method for generating a user interface of a network node. An application is structured into a core application part responsible to handle data objects and a viewer/controller application part responsible to display said data and to initiate actions on said data, wherein said viewer/controller application part is formed by said user interface. A screen mask creating module (240) retrieves screen mask configuration data (320) and widget configuration data (310). A widget creating module (230) generates at least one user interface component (10-18; 410) on the basis of one ore more component pattern (411, 412). A screen mask of said user interface is generated y said screen mask creating module (240), wherein said screen mask comprises at least one component which is a component out of said components comprised by the widget configuration data. Said at least one component is assigned to at least one data object and/or dynamic behaviour of said components assigned to said screen mask based up a user action on a user interface component and/or a data object.

The present invention relates to a method for generation of a user interface. In particular, the present invention relates to a method for generation of graphical user interfaces (GUI) on the basis of a central configuration arrangement. More particular, the method takes considerations of a JAVA programming environment and employs a central configuration arrangement, which is coded in a universal markup language such as the extensible markup language.

Modern applications are typically structured into several application layers, which communicate via appropriately designed application layer interfaces. The separation of applications into several application layers is clearly apparent when considering complex application projects, in which functionality of application parts has to be handled in a clear and concise way, especially when numerous developers are involved in realizing the complex application projects. The layered structure of complex applications allows for assigning functionality, which is established by one or more application layer functions, in a preferably unambiguous manner to certain application layers. Moreover when referring to developers involved in realization of complex applications independent developer groups of the total number of involved developers can be assigned to attend to distinct application layers such that competence and responsibility are shared and distributed to dedicated single groups, whereby uncertainty and overlapping is avoided, respectively.

In detail when considering a typical client application in a client-server environment such an application is often separated into a model layer application part, a viewer application part and a controller application part which implement model, view and controller pattern. The illustrated separation is just exemplary. The following explanation is also applicable with alternative more delicate separations. The model layer is dedicated for data handling; which is for example requesting, retrieving, communicating and/or storing data. The viewer layer addresses a presentation of the handled data; which is for example rendering and displaying of the data. The controller layer arbitrates between the model and the view layer; that is the controller layer catches events released by users and requests actions of the model layer, which impacts on the viewer layer for presentation. In typical client applications this enlightened layer structure design is well suited to display common parts of the same data on multiple screen masks. All controller layer application parts will act of the same model pattern such that all viewer layer application parts display the same data. In case of a field within the presentation of the data is modified the associated controller layer application part updates the model pattern such that the model layer application part notifies connected presentation elements provided by the viewer layer application part in order to effect updates presentation of the data.

It is self-explanatory that the layer design although structured into separate layers does not allow for independent implementation. Developers have to take care about consistency between the model layer application part and the connection of the viewer and controller layer application parts due to the involvement with each other. The maintaining of consistency counteracts the initial idea of a separate layered application design. That means, developers which deal with model pattern and model layer application part design, have to maintain in parallel aspects of the viewer layer application part and controller layer application part or to be more general aspects of the view and controller pattern.

It is an object of the present invention to simplify the design and generation of user interfaces which include aspects of the viewer layer application part and controller layer application part. In particular, the user interface and to be precise a graphical user interface (GUI) is generated dynamically at runtime such that model layer application part and viewer/controller layer application part are clearly separated.

The object of the present invention is solved by a method for providing a screen mask of a user interface and a terminal device, which is adapted to perform this method.

According to an aspect of the invention for generating a user interface of a network node, whereas the user interface (GUI) is operable by a user to operate an application, the application is structured into a core application part responsible for handling data objects and a viewer/controller application part responsible for displaying said data and initiating actions on said data, wherein said viewer/controller application part is formed by said user interface, whereas a screen mask creating module for creating dynamically a screen mask of said user interface retrieves screen mask configuration data and widget configuration data over a network which are stored on a central processing unit, whereas a widget creating module generates at least one user interface component on the basis of one or more component patterns of the widget configuration data and stores the at least one user interface component by means of a widget cache, whereas a screen mask of said user interface is generated by said screen mask creating module, wherein said screen mask comprises at least one component which is a component out of said components comprising the widget configuration data, and whereas said at least one component of said created screen mask is assigned to at least one data object and/or dynamic of said components assigned to said screen mask based upon a user action on a user interface component and/or a data object. Said screen mask of said user interface can e.g. dynamically be generated by said screen mask creating module. Said screen mask configuration data and/or widget configuration data can e.g be at least partially changed dynamically based upon one or more user actions.

Widget is understood within this document as a generic term all kind of parts of the GUI, in particular those parts, which allows the user to interface with the application and operating system. Widgets can e.g. display information and/or invite the user to act in a number of ways. Typically, widgets can e.g. include buttons, dialog boxes, pop-up windows, pull-down menus, icons, scroll bars, resizable window edges, progress indicators, selection boxes, windows, tear-off menus, menu bars, toggle switches and/or forms. Widgets can e.g. also refer to the program that is written in order to make the graphic widget in the GUI look and perform in a specified way, depending on what action the user takes while interfacing with the GUI. Therefore, widget can e.g. refer to either the graphic component or its controlling program or to the combination of both. Again, the user interface (GUI) is operable by a user to operate an application. The application is structured into separate layers; i.e. a core application layer which is responsible to handle data objects and data of the data objects and a viewer/controller application layer, which is responsible to display data contained in one or more data objects and to initiate actions (events) on the data and the data objects, respectively. The viewer/controller application layer is formed by the user interface (GUI). Central configuration information is provided, which comprises a widget configuration data and at least one screen mask configuration data. The widget configuration comprises in particular widget configuration data about all components, which are available to be included in screen masks of the user interface. More particularly, the widget configuration comprises widget configuration data about component patterns and the components are user interface components also known as widgets. The components are operable as one component out of group components, which comprises a component for outputting data, a component for inputting data and component for both outputting and inputting data. The screen mask configuration comprises in particular screen mask configuration data about a predetermined screen mask of the user interface. The screen mask comprises at least one component, which is a component out of the group of components comprised by the widget configuration. The predetermined screen mask of the user interface is created on the basis of the central configuration information and the at least one component of the screen mask is linked to at least one data object. The linking enables that an action, which is initiated via the at least one component effects the data object and that a modification, which has effected the data object is noticed by the at least one component such that the component can react correspondingly. The appearance of the user interface is defined by the central configuration information. Modifications on the appearance of the user interface are obtainable by modifications on the central configuration information.

According to an embodiment of the invention, the screen mask configuration is retrieved to dynamically create the screen mask to be operable with the user interface. As aforementioned, the screen mask configuration includes, among others, data about at least one component, which will be designated in the following as user interface component. The user interface component may be an input component, which is operable by a user for inputting data, information and/or instructions, onto which an application controlled by the user interface reacts by operations, the user interface may be an output component, which is dedicated to display information provided thereto, or the user interface component is an input/output component, which is adapted for inputting and outputting as aforementioned.

The screen mask configuration information is parsed and analyzed to extract type information about the at least one user interface component and to extract individual settings (and properties) of the at least one user interface component. The at least one user interface component is obtained on the basis of at least one component pattern, which corresponds to the extracted type information and which is provided in conjunction with the widget configuration. The extracted individual settings (and properties) are applied onto the at least one user interface component obtained by deriving and the at least one user interface component is included into the dynamically created screen mask.

The at least one user interface component of the screen mask is linked to at least one data object, which is preferably provided by a data object container associated to the screen mask. The linking allows for adapting the screen mask and the user interface components included in the screen mask, respectively, which may be necessary in case modifications have been performed to the linked data object such that an updating (refreshing, repainting, . . . ) of the screen mask is required to display valid information thereon.

According to an embodiment of the invention, the obtaining is initially started by a request for the at least one user interface component, which is to be obtained on the basis of at least one component pattern, which is to be retrieved from a component pattern repository, which caches at least one component pattern. In accordance with the request, the at least one component pattern, which corresponds with the extracted type information is identified in the component pattern repository and at least one user interface component is derived from the at least one identified component pattern. The at least one derived user interface component is finally passed back in accordance with the request.

According to an embodiment of the invention, the component pattern repository is initialized previously. The initialization is based on a widget configuration, which comprises widget configuration information about at least one component pattern. The widget configuration is parsed and on the basis of the parsing results, the at least one component pattern corresponding to the widget configuration information is created. The at least one created component pattern is stored/cached in the component pattern repository.

According to an embodiment of the invention, the component pattern repository contains statically the at least one component pattern, i.e. statically during runtime of the user interface and the application that is controlled by the user interface, respectively.

According to an embodiment of the invention, the obtaining of the at least one user interface component comprises a request for the at least one user interface component, which is to be obtained on the basis of at least one component pattern. A widget configuration is provided, which comprises widget configuration information about at least one component pattern. Widget configuration information about the at least one component pattern, which corresponds to the extracted type information is identifies and parsed. On the basis of the parsing results, the at least one component pattern is created and the at least one user interface component is derived from the at least one component pattern. Finally, the at least one user interface component is passed back.

According to an embodiment of the invention, the deriving of the at least one user interface component comprises further a cloning procedure, which allows to obtain the at least one user interface component in a heredity process from the at least one component pattern.

According to an embodiment of the invention, the widget configuration comprises default widget configuration information about at least one component pattern. That means that the user interface components, which are obtained from the least one component pattern, each have default settings (and properties), which are substantially valid for each screen mask, into which the user interface components are included.

According to an embodiment of the invention, the screen mask configuration comprises screen mask configuration information about at least one user interface component. The screen mask configuration information is required to adapted user interface components, which are obtained from component patterns by deriving, to individual requirements, which are presupposed by the screen mask to be created.

According to an embodiment of the invention, the screen mask configuration is an XML-encoded screen mask configuration, which is based on a screen mask document type description (DTD).

According to an embodiment of the invention, the widget configuration is an XML-encoded widget configuration, which is based on a widget document type description (DTD).

According to an aspect of the invention, a software tool for establishing a user interface (GUI) is provided. The software tool comprises program portions for carrying out the operations of the aforementioned methods when the software tool is implemented in a computer program and/or executed.

According to an aspect of the invention, there is provided a computer program product for establishing a user interface (GUI). The computer program comprises program code portions directly loadable into a local memory of a microprocessor-based component, processing device, a terminal device, a communication terminal device, a serving device or a network device for carrying out the operations of the aforementioned methods when the program is executed thereon.

According to an aspect of the invention, a computer program product for establishing a user interface (GUI) is provided which comprises program code portions stored on a computer readable medium for carrying out the aforementioned methods when the program product is executed on a microprocessor-based component, processing device, a terminal device, a communication terminal device a serving device or a network device.

According to an aspect of the invention a computer data signal is provided which is embodied in a carrier wave and represents instructions which when executed by a processor cause the operations of anyone of the aforementioned methods to be carried out. Thereby Internet applications of the invention are covered.

According to an aspect of the invention, a terminal device is provided, which processes a client application with a user interface for displaying content of at least one data object to a user. The terminal device further includes a screen mask creating module for dynamical creation of a screen mask of the user interface (GUI). The screen mask creating module preferably embeds a retrieval component, which allows for retrieval of a screen mask configuration. The screen mask configuration comprises, among others, screen mask configuration information about at least one user interface component, which is parsed by an adequate parser (parsing component) such that type information about the at least one user interface component and individual settings (and properties) of the at least one user interface component are available from the screen mask configuration. The at least one user interface component is obtained by a widget creating module on the basis of at least one component pattern, which corresponds to the type information and the individual settings (and properties) are applied additionally onto the at least one derived user interface component.

The at least one user interface component is preferably logically linked together by a linking/binding component with at least one data object which includes data content relating to the at least one user interface component. The linking ensures that in case of modifications occur, which affects the at least one linked data object, the displaying of the user interface component included in the screen mask is updated.

According to an embodiment of the invention, a component pattern repository is provided, which caches at least one component pattern and from which at least one user interface component can be requested. An identification component allows for identification of at least one component pattern, which corresponds to the extracted type information. The widget creating module is further adapted to derive at least one user interface component from the at least one identified component pattern.

According to an embodiment of the invention, the terminal device comprises further components for initializing the component pattern repository. A retrieval component is adapted to provide a widget configuration, which comprises, among others, widget configuration information about at least one component pattern, which is analyzed by a parser (parsing component). In conjunction with the parsing results, the widget creating module is adapted to create the at least one component pattern and to store/cache the at least one created component pattern in the component pattern repository.

According to an embodiment of the invention, the terminal device further comprises a retrieval component, which allows for retrieval of a widget configuration. The widget configuration includes, among others, widget configuration information about at least one component pattern, which is analyzed by a component of identifying the widget configuration information about the at least one component pattern, which corresponds to the extracted type information. The identification widget configuration information is parsed by a parser (parsing component) and on basis of the parsing results, at least one component pattern is created and at least one user interface component is derived therefrom by the widget creating module adapted thereto.

The accompanying drawings are included to provide a further understanding of the invention and are incorporated in and constitute a part of this specification. The drawings illustrate embodiments of the present invention and together with the description serve to explain the principles of the invention. In the drawings,

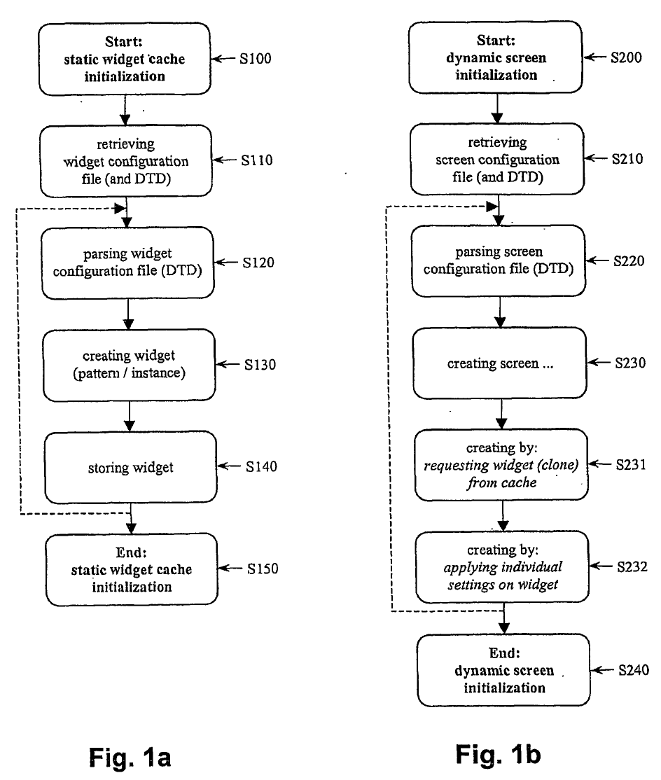

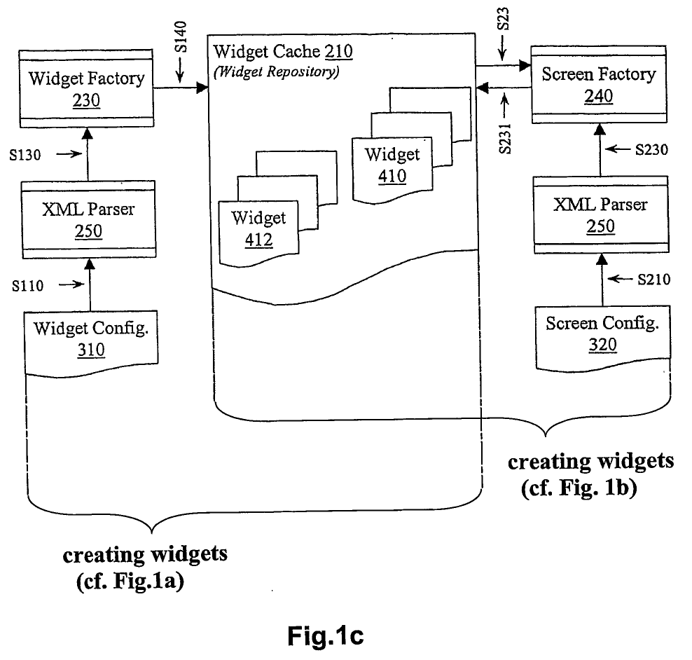

FIG. 1a illustrates an initial operational sequence for initializing a widget cache according to an embodiment of the invention;

FIG. 1b illustrates an operational sequence for creating a screen mask according to an embodiment of the invention;

FIG. 1c depicts a component model, which illustrates components performing the operational sequences illustrated in FIG. 1a and FIG. 1b according to an embodiment of the invention;

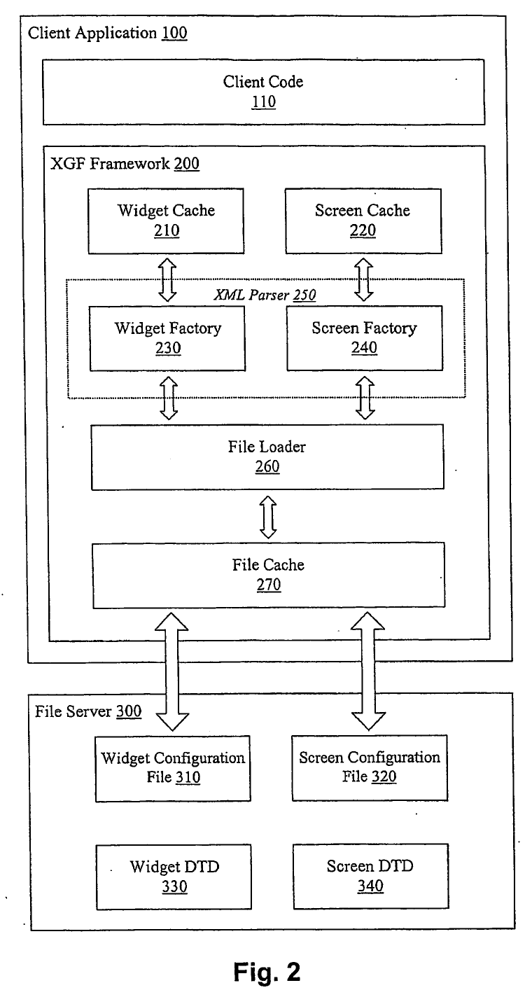

FIG. 2 depicts a component model, which illustrates the XGF framework in an example client-server environment according to an embodiment of the invention;

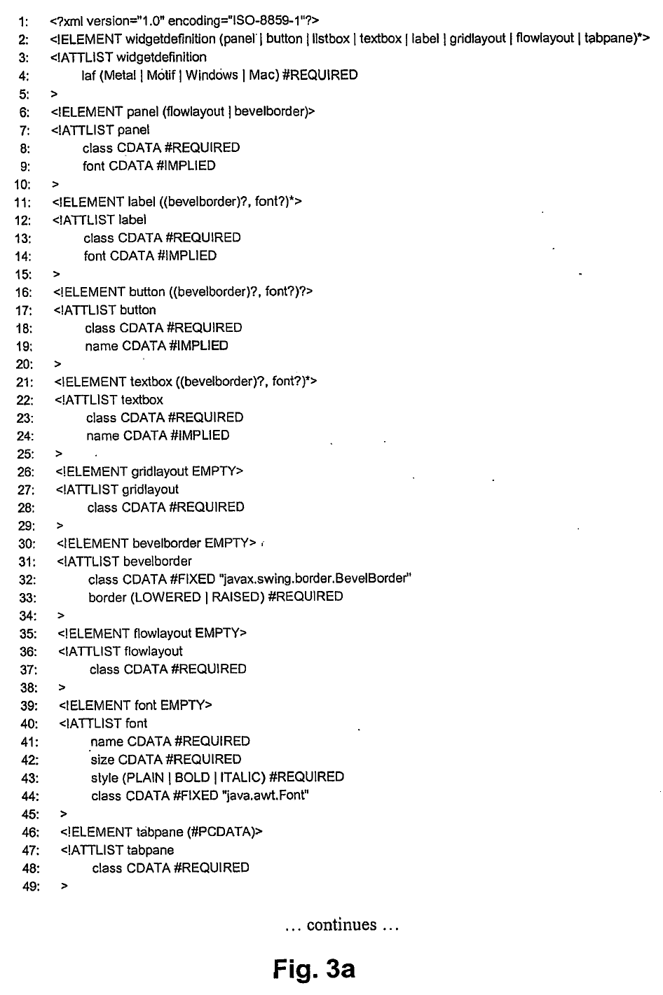

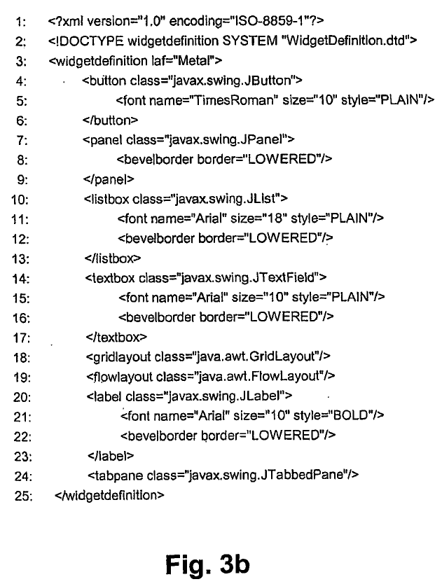

FIG. 3a shows a clear text coding of an example document type description, which includes type definitions of several widgets according to an embodiment of the invention;

FIG. 3b shows a clear text coding of an example widget configuration, which includes common property settings on the basis of the document type description shown in FIG. 3a according to an embodiment of the invention;

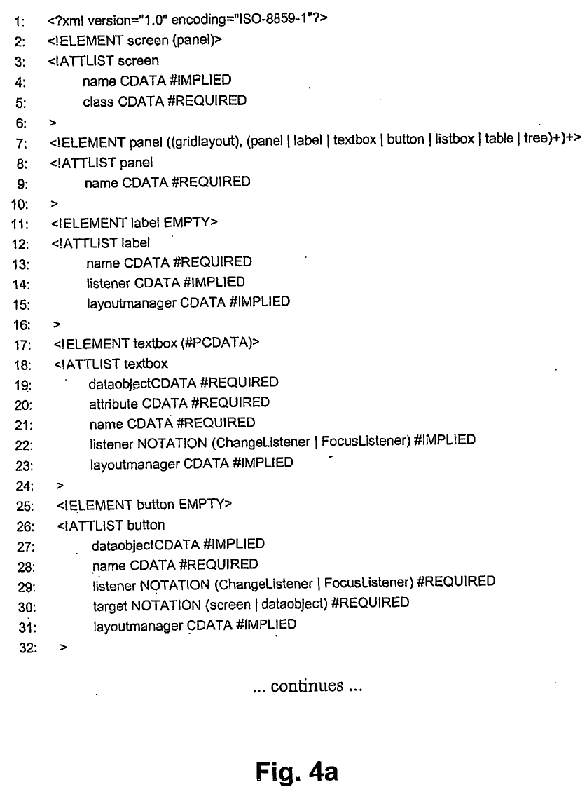

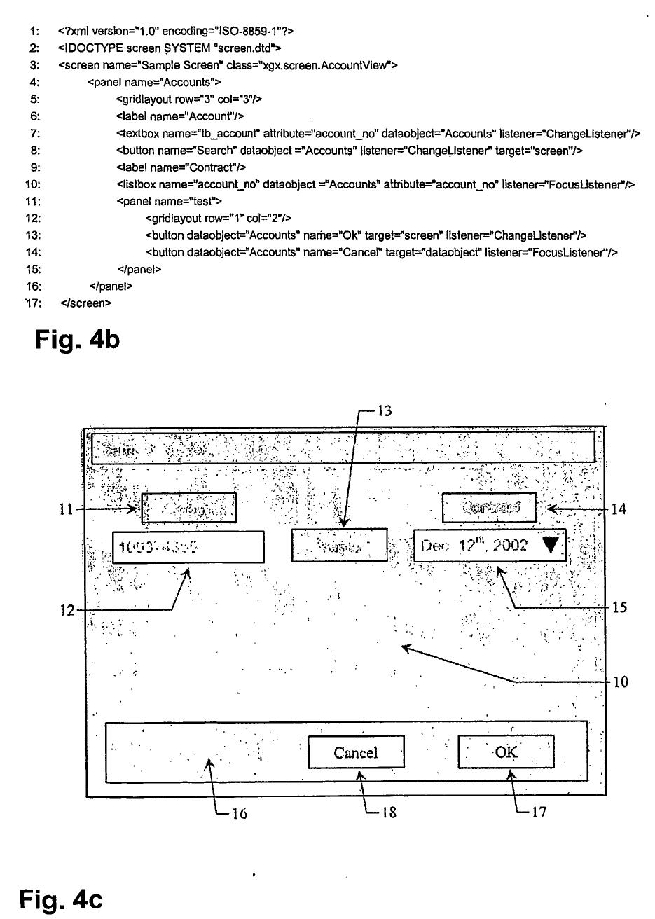

FIG. 4a shows a clear text coding of an example document type description, which includes type definitions of screen masks according to an embodiment of the invention;

FIG. 4b shows a clear text coding of an example screen mask configuration on the basis of the document type description shown in FIG. 4a according to an embodiment of the invention;

FIG. 4c depicts an example screen mask, which corresponds to the example screen mask definition shown in FIG. 4b according to an embodiment of the invention;

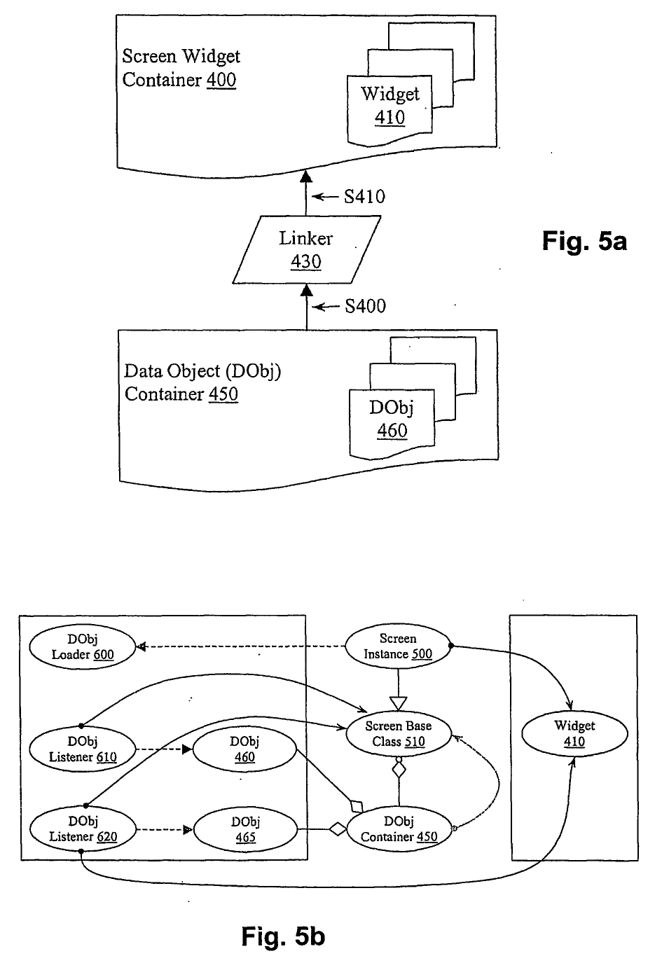

FIG. 5a illustrates a schematic diagram which illustrates the binding of data objects and widgets according to an embodiment of the invention; and

FIG. 5b illustrates a schematic diagram that depicts the logical linkage of components interacting with each other on handling a data object change notification according to an embodiment of the invention.

Reference will be made in detail to the embodiments of the invention examples of which are illustrated in the accompanying drawings. Wherever possible the same reference numbers are used in the drawings and the description to refer to the same or like parts.

The following description for enlightening the inventive concept of the present invention will be given in view of a user interface, which is presented to a user of a client application, which preferably is operable with a data management application such as a database management system (DBMS). The data management application may preferably be networked application and a server application, respectively, such as known in typical client-server environments, in which one or more client terminals are operable with the client application and a central server device is operable with the networked data management application. The user interface in question is preferably a graphical user interface (GUI), which includes graphical elements comprising screen masks and graphical components included in the screen masks. A screen mask shall be understood as a presentation area, upon which a plurality of graphical components is arranged. For simplicity the term screen mask will be abbreviated in the following description as screen. Correspondingly, compound words containing the term screen mask will analogously simplified by including the term screen. The components are input/output elements of the graphical user interface (GUI), which on one side allow for displaying data (corresponding to viewer layer) and which on the other side allow for inputting requests (corresponding to controller layer). The graphical components are also commonly designated as widgets.

The description will first introduce into creating and providing of component entities and in particular component patterns and component instances, respectively. The component patterns are made available statically during runtime of the client application. The statically provided component patterns serve as basis of patterns to retrieve dynamically components and component instances, respectively, which are to be included into dynamically created screens. In particular, the components to be included into a dynamically created screen are obtained by a deriving process or cloning process from the statically provided component patterns. In the following the above described components patterns and component (and component entities, respectively) will be designated as widget patterns and widget (and widget entities, respectively), without limiting the invention thereto.

FIG. 1a illustrates an initial operational sequence for creating widget patterns and for initializing a widget repository including the created widget patterns according to an embodiment of the invention.

In an operation S100, a creating of widget patterns and an initializing of an adequate widget repository with the created widget patterns is started. The widget repository or widget pattern repository is a static collection of widget patterns. The designation “static” shall be understood as static during runtime of the application and wherein the widget patterns stored in the widget repository shall be also understood as basis of patterns, on the basis of which widgets of a graphical user interface (GUI) are derived and cloned, respectively. Herein, the widget repository area will also be referred as widget storage and widget cache, respectively.

In an operation S110, a widget configuration is retrieved. The widget configuration comprises information about properties and settings applicable to widgets defined therein. In particular the widget configuration is provided as a widget configuration file stored centrally. The widget configuration primarily relates to common (global) properties and settings of default widgets, which at least allow for establishing a common look and feel of the graphical user interface (GUI) composed thereof. The common look and feel of graphical user interface (GUI) and elements/components therefor is one of the essential features, which have to be taken into consideration to enable a convincing, user-friendly and intuitive operativness of the graphical user interface (GUI), and thus of the client application that communicates with the user via the graphical user interface (GUI).

More particular, in accordance with one preferable embodiment of the invention the widget configuration is based on the extensible markup language (XML). The extensible markup language (XML) is a universal language construct which allows for coding arbitrary information, the meaning of which is defined by language tags and markups, respectively, which are defined and described in a corresponding document type description (DTD). A detailed description of the application of XML-coded widget configuration on the basis of a widget document type description (DTD) will be referred to in FIG. 3a and FIG. 3b.

In an operation S120, the widget configuration is parsed. The parsing and interpreting of the widget configuration, which is preferably XML-coded, is performed on the basis of pre-defined parsing agreements, in particular on the basis of a corresponding document type description (DTD). The pre-defined parsing agreements, i.e. the document type description (DTD), ensure that the parsing is operable and parsing results are unambiguous. In an operation S130, a widget pattern is created in accordance with the parsing results. And in an operation S140, the created widget pattern is stored in the dedicated widget repository such that the created widget pattern is retrievable for further employment such as in particular for including widgets into a dynamically created screen, which is described in following FIG. 1b.

The operations S120 to S140 have been described with respect to parsing of the widget configuration, creating of a widget pattern and storing the created widget pattern. The widget configuration may relate one or more different widgets, which lead to one or more widget patterns. Correspondingly, either the operations S120 to S140 are repeated subsequently for each individual widget/widget pattern as illustrated in FIG. 1a or each operation of the operations S120 to S140 performs immediately for each widget/widget pattern to be created and stored such that a repetition of the operations S120 to S140 is not necessary.

In an operation S150, the creation of widget patterns defined in the widget configuration is finished and the created widget patterns are stored in the widget repository for further employment.

FIG. 1b illustrates an operational sequence for dynamical creating a screen on the basis of the widget patterns provided by the widget repository according to an embodiment of the invention.

In an operation S200, a dynamical creating of a screen on the basis of a previously created and initialized widget repository is started. The widget repository is a static collection of widget patterns. The designation static shall be understood as static during runtime of the application and the widget patterns stored in the widget repository shall be also understood as widget patterns, by the means of which widgets (widget instances) are derived and cloned, respectively, to be included into a dynamically created screen of a graphical user interface (GUI).

In an operation S210, a screen configuration is retrieved. The screen configuration comprises information about widgets to be included into the screen and properties and settings applicable with the distinct screen and the components thereof, respectively. In particular the screen configuration is provided as a screen configuration file stored centrally. The screen configuration relates to properties and settings of the screen in question, screen related properties and settings of widgets (widget instances), exceptional properties and settings of widgets (widget instances) included in the screen, arrangement of the widgets on the screen.

More particular, in accordance with one preferable embodiment of the invention the screen configuration is based on the extensible markup language (XML) in conjunction with a corresponding appropriate screen document type description (DTD). A detailed description of the application of XML-coded screen configuration on the basis of the screen document type description (DTD) will be referred to in FIG. 4a and FIG. 4b.

In an operation S220, the screen configuration is parsed. The parsing and interpreting of the screen configuration, which is preferably XML-coded, is performed on the basis of pre-defined parsing agreements, in particular on the basis of a corresponding document type description (DTD). The pre-defined parsing agreements, i.e. the document type description (DTD) ensures that the parsing is operable and parsing results are unambiguous.

In an operation S230, the screen is dynamically created in accordance with the parsing and parsing results, respectively.

In a sub-operation S231, a widget to be included into the screen is preferably requested from the widget repository. The widget repository caches widget patterns. The request instructs to deliver a widget and a widget instance of a certain predetermined widget type, respectively. The type information on the basis of which the widget is requested is received from the parsing operation and can be concluded from the screen configuration, which defines all widgets to be included in the screen in question.

In detail the request for a widget and widget instance may require an identifying of that widget pattern, which corresponds to the widget currently in question. A corresponding widget pattern may be obtained from the widget repository, which provides statically a total collection of widget pattern, which may be employed in screens of the graphical user interface (GUI). On basis of the identified widget pattern a widget and a widget instance is created, respectively. That means, the widget is derived or cloned from the widget pattern such that the default properties and settings, which have been applied to the widget pattern during creation thereof, get valid for the obtained widget and widget instance, respectively. This is to ensure the look and feel defined in view of the overall substantially identical widget representation of the graphical user interface.

In a sub-operation S232, individual properties and settings, which are instructed and provided by the screen configuration with respect to the widget currently in question, are applied to the requested widget. The individual properties and settings may comprise screen related properties and settings, which have to be applied to the widgets of the screen to enable a suitable operation in view of the screen function. The individual properties and settings may also comprise exceptional properties and settings, which are applied to depart from the default settings, which result from the deriving and cloning process for creating the widget in question from the corresponding identified widget pattern, respectively. More commonly, the widget in question obtained from the widget pattern is adapted to screen related necessitates and requirements.

The operations S220 to S232 have been described with respect to parsing of the screen configuration and creating of the screen by requesting a widget from the widget repository and applying individual properties and settings onto the widget obtained by the request. The screen configuration may define one or more different widgets to be included in the screen in question. Correspondingly, either the operations S220 to S232 (or the operations S230 to S232) are repeated subsequently for each individual widget as illustrated in FIG. 1b or each operation of the operations S220 to S232 performs immediately for each widget to be created and included such that a repetition of the operations S220 to S232 is not necessary.

In an operation S240, the dynamical creating of the screen on the basis of a previously created and initialized widget repository is finished.

FIG. 1c depicts a first component model, which illustrates components, which allow for performing the operational sequences illustrated in FIG. 1a and FIG. 1b according to an embodiment of the invention. A first part of the illustrated component model relates to the method of creating widget patterns and initialization of the widget repository with the created widget patterns according to an embodiment of the invention. A second part of the illustrated component model relates to the method of dynamical creating a screen of a graphical user interface (GUI) on the basis of previously created widget patterns stored in the widget repository.

The first part is exemplary composed of a widget configuration 310, which is provided for defining default widget patterns. Preferably, the widget configuration 310 is stored in an adequate storage component (not shown), which allows for storing and retrieving the widget configuration 310. In the operation S110, the widget configuration is retrieved or read from the storage component and supplied to a parsing component, which is herein embodied as an XML parsing component and an XML parser 250, respectively. The XML parser 250 is responsible for parsing the widget configuration 310 in the operation S120 and supplies parsing results to a widget creating module and a widget factory 230, respectively, for creating in the operation S130 one or more widget patterns on the basis of the parsing results. Finally in the operation S140, the created widget patterns are passed on to a widget cache 210, which caches/stores the created widget patterns such as exemplary widget patterns 411 and 412.

The second part is exemplary composed of a screen configuration 320, which is provided for defining a certain predetermined screen. Preferably, the screen configuration 320 is stored in an adequate storage component (not shown), which allows for storing and retrieving the screen configuration 320. In the operation S210, the screen configuration is retrieved or read from the storage component and supplied to a parsing component, which is herein embodies as an XML parsing component and an XML parser 250, respectively. The XML parser 250 is responsible for parsing the screen configuration 320 in the operation S220 and supplies parsing results to a screen creating module and a screen factory 240, respectively, for creating in the operation S230 the screen on the basis of the parsing results. The creating of the screen by the screen factory 240 includes in the operation S231 a requesting of one or more widgets. One or more requests for widgets are addressed to the widget cache 210 and the one or more requests are answered by responses comprising corresponding widgets and widget instances, respectively, which are obtained for the widget patterns serving as a basis of patterns, which are cached in the widget cache 210. The cloning of a widget pattern to obtain a widget and widget instance, respectively, is preferably performed by the widget factory 230 but may be also carried out by the screen factory 240. The designation “cloning” should be understood as a creating of a widget on the basis of a corresponding widget pattern by passing on properties and settings defined in conjunction with the widget pattern to the widget. The passing on may be understood as heredity of properties and settings, which is known in the field of object-oriented modeling and programming. Finally, the created screen may be provided to the graphical user interface (GUI; not shown) for being displayed and/or may be passed on to a screen cache (not shown) for caching (storing) the created screen for later use.

FIG. 2 depicts a second component model, which illustrates the XML-based graphical user interface factory (XGF) framework in an example client-server environment according to an embodiment of the invention. The FIG. 2 illustrates details on an example XGF core architecture structured in components, which allow for performing the aforementioned method for creating widget patterns and for initialization of the widget repository and the aforementioned method for dynamically creating a screen according to embodiments of the invention. This XGF framework is preferably embedded as an application part or application layer into the client application, to which the graphical user interface (GUI) in question belongs.

In detail, the client application 100 comprises a client code component/section 110 and an XGF framework component/section 200. The client application 100 may be carried out on one or more suitable processing devices (not shown) such as microprocessor-based terminals (PC, network clients etc.). A file server 300 serves for providing the widget configuration 310, the screen configuration 320, the widget document type description 330 and the screen document type description 340. The file server 300 and the processing devices carrying out the client application 100 communicate with each other via a data communication network such as a local area network or any other suitable network. Alternatively, the configurations 310 and 330 as well as the document type descriptions 330 and 340 may be included in the XGF framework component 200. In a client-server environment, in which client applications access data which is managed centrally on a server such as a database management server, it is advantageous to centralize also configuration information, which is to be supplied to the client applications since the network and server framework is already available. In case of changes on the configuration information the changes have automatically effect on each client application.

The XGF framework component 200 comprises further a file loader interface 260, which is responsible for retrieving the configurations 310 and 330 as well as the document type descriptions 330 and 340 from the file server 300. An interconnected file cache 270 may be employed to cache the configurations (310, 320) and descriptions (330, 340) to increase the processing speed by obviating the necessity of retrieval of the configurations and descriptions from the file server 300. The file cache 270 may be implemented as a local mass storage component (e.g. hard disk) and a timestamp identification of the configurations and the descriptions may be used to identify modified configurations and/or descriptions such that a well-dedicated re-retrieval of the changed configurations and/or descriptions is operable.

The file loader interface 260 supplies the configurations 310 and 330 as well as the document type descriptions 330 and 340 to the widget factory 230 and the screen factory 240, respectively. The widget factory 230 and the screen factory 240 are adapted to carry out the corresponding aforementioned methods according to embodiments of the invention.

In detail, the widget factory 230 is adapted to carry out the operational sequence for creating widget patterns and for initialization of the widget repository caching the created widget patterns according to an embodiment of the invention. The widget factory 230 may be a code section comprising instructions which when carried out on a processing device (e.g. microprocessor based terminal) performs the aforementioned method. In particular, the widget factory 230 may be part of a parser 250, which is adapted to parse and interpret XML-coded configurations. The widget factory 230 is adapted to parse the widget configuration 310 and stores/caches the created widget patterns in the widget cache 210 associated with the widget factory 230. The created widget patterns act as patterns having default properties and settings pre-determined in the widget configuration 310 for the graphical user interface (GUI), which serves user as the interface of the client application 100. The default properties and settings relate primarily to a common look and feel of the graphical user interface (GUI) representation. The widget patterns stored in the widget cache 210 are statically available during runtime of the client application 100.

In detail, the screen factory 240 is adapted to carry out the operational sequence for dynamical creating a screen on the basis of widget patterns provided by the widget repository according to an embodiment of the invention. The screen factory 240 may be a code section comprising instructions which when carried out on a processing device (e.g. microprocessor based terminal) performs the aforementioned method. In particular, the screen factory 240 may be part of a parser 250, which is adapted to parse and interpret XML-coded configurations. The screen factory 240 is adapted to parse the screen configuration 320 and to dynamically create a screen for being presented to the user within the context of the graphical user interface (GUI) of the client application 100. A screen cache 220 allows for storing/caching created screens, which enables a seeding up of screen representation in case a previous created screen is to be displayed again.

The deriving of widgets from widget patterns, which are cached in the widget cache (widget repository) 210 may be performed by the widget factory 230 or by the screen factory 240. Preferably, the widget factory 230 is responsible for deriving (cloning) a widget from a corresponding widget pattern.

Moreover, the screen factor 240 is further adapted to link data objects and dynamically created screens with each other. In particular, the screen factor 240 is further adapted to link data objects and widgets included in the dynamically created screens with each other. A detailed description of the linking and the purposes thereof is described below with reference to FIG. 5a and FIG. 5b.

The following FIG. 3a to FIG. 4b depict an example widget document type description (DTD), an example XML-based widget configuration, an example screen document type description (DTD), an example XML-based screen configuration. The presented example document type descriptions and example configuration files comprises elements, which refer to JAVA programming language.

It is to be understood that the references to the JAVA programming language as well as the concrete XML-coding are not limiting to the scope of the present invention. The adaptation to other programming languages and GUI libraries is possible. Moreover, the depicted XML-coding scheme is not limited to the depicted XML version and the character encoding (ISO 8859-1), respectively. A detailed description of the aspects of the extensible markup language (XML) and in particular of the notation of XML document type descriptions may be found in “Extensible Markup Language (XML) 1.0 (Second Edition)”, W3C Recommendation 6 Oct. 2000, published by the World Wide Web Consortium.

With respect to the following aforementioned examples, a document type description comprises sets of declarations that provide a grammar for a class of documents that refer to that document type description. Each set of declaration may be an element type declaration having one or more attribute type declarations associated to the element type declaration. In particular, an element type declaration has one or more attribute type declarations arranged hierarchically subordinated. The XML-based configurations are drawn up and parsed on the basis of these grammatical declarations provided by the document type description.

FIG. 3a shows a clear text coding of an example widget document type description, which includes type declarations of several widgets according to an embodiment of the invention. The presented widget document type definition (DTD) specifies element type declarations and one or more attributes assigned to a corresponding element type declaration. Each element type declaration in conjunction with its assigned attribute type declarations refers to a widget and its properties for an individual widget configuration. Moreover, the type declaration specifies the hierarchy for the widget configuration.

In line 2 an element “widgetdefinition” is defined and the element type declaration specifies that the element “widgetdefinition” may comprise one or more further specified elements (cf. line 2: “panel”, “button”, “listbox” . . . “tabpane”) to be arranged hierarchically subordinated. Moreover, the element type “widgetdefinition” has further assigned an attribute type declaration which includes an attribute “laf” (abbr.: look and feel), which is specified to be obligatory and to have assigned one of the possible attribute values “metal”, “motif”, “windows”, “mac”.

In lines 6, 11, 16, 21, 26, 35 and 46 are denoted the element type declarations of the elements which are allowed for being included in the element “widgetdefinition”.

For example, the element “button” is defined in line 16 and relates to the element type declaration of the widget “button”. The type declaration of the element “button” specifies that elements “bevelborder” and “font” may be included in the definition of the element “button”. The element type declarations of the elements “bevelborder” and “font” follows from the lines 30 to 34 and lines 39 to 45, respectively. Further, an attribute type declaration comprising two attributes of the element “button” is specified in lines 17 to 20. The attributes comprise an attribute “class” (cf. line 23) and an attribute “name” (cf. line 24). The attribute “class” is defined as obligatory whereas the attribute “name” is defined as optional. Both attributes are defined to accept character-encoded data content (CDATA).

The element type declaration of the element “font” relates to a font appearance definition and is denoted in lines 39 to 45. The element “font” is a subordinated element to be included in element definitions, which relate to widget elements such as the element “button” explained above. The element “font” comprises an attribute type declaration, which includes four attributes. The attributes “name” (cf. line 41), “size” (cf. line 42) and “style” (cf. line 43) are specified as obligatory and the attributes “name” and “size” are defined to contain character-encoded data content, whereas the attribute “style” is defined to have one value out of the group “plain”, “bold” and “italic”. The attribute “class” is defined to contain constant data and has assigned fixly a constant JAVA class definition.

The element type declaration of the element “bevelborder” relates to a border styling and is denoted in lines 30 to 34. The element “bevelborder” is a subordinated element to be included in element definitions, which relate to widget elements such as the element “button” explained above. The element “bevelborder” comprises an attribute type declaration which includes two attributes: the attribute “class” (cf. 32), which is defined to contain constant data and has assigned fixly a constant JAVA class definition, and the attribute “border” (cf. line 33), which is defined as obligatory and to have one value out of the group “lowered” and “raised”.

The given above explanation of the elements “button”, “font” and “bevelborder” introduces exemplary in the denotation of the widget document type definition. On basis of the aforementioned description the further element type declarations can be understood. Moreover, the description will be more apparent when referring to FIG. 3b.

FIG. 3b shows a clear text coding of an example widget configuration, which includes common widget property settings and which is coded on the basis of the document type description described with respect to FIG. 3a according to an embodiment of the invention. The widget configuration comprises only a selection of individual widget definitions, on the basis of which widget patterns are derived such as described with reference to FIG. 1a. In accordance with the widget DTD (cf. FIG. 3a and description) the widget configuration begins with the widgetdefinition element in line 3. The individual widget definitions of individual widget patterns are arranged hierarchically subordinated to the element “widgetdefinition”, such that lines 4 to 6 include an individual widget definition “button”, lines 7 to 9 include a an individual widget definition “panel”, lines 10 to 13 include an individual widget definition “listbox”, lines 14 to 17 include an individual widget definition “textbox” and lines 20 to 23 include an individual widget definition “label”.

In accordance with the function of the widget configuration, each individual widget definition includes a set of default attribute definitions. For example, the definition “textbox” includes an attribute “class”, which is assigned in line 14 to a component class of the JAVA programming language. Further, the definition “textbox” specifies in line 15 an element “font” and property attributes thereof, which are arranged hierarchically subordinated to the definition “textbox”; i.e. the attribute “name” of the font (“Arial”) to be used, the attribute “size” of the font (“10” pt) and the attribute “style” of the font (“plain”). In line 16 the definition “textbox” includes also an element “bevelborder” and a property attribute thereof, which are arranged hierarchically subordinated to the definition “textbox”; i.e. the attribute “border” set to “lowered”. The assignments of the attributes to certain predetermined values form the default configuration of the widget pattern “textbox”, on the basis of which one or more widgets to be displayed in conjunction with the graphical user interface (GUI) are requested. Due to this default configuration of the definition “textbox”, “textbox” widgets, which may be included into a created screen, show all the same appearance; i.e. have the same look and feel.

Analogously, the description given above with reference to the widget definition “textbox” applies also in a similar way to the further widget definitions. As an example in short, the widget definition “label” comprises assignments of an attribute “class”, an element “font”, which comprises the aforementioned font attributes, and an element “bevelborder” which comprises the aforementioned border attribute.

Conclusively, it shall be understood that the widget document type definition (DTD) specifies the elements, attributes, types of the attributes, the hierarchical structure of the elements and attributes and the totally supported and available grammatical elements of the widget configuration, which is coded as an XML file and which is based on the grammatical elements specified in the widget document type definition (DTD). In accordance with an embodiment of the invention, the definitions specified in the widget configuration are default definitions; this is the definitions may not include all definitions specified as being obligatory and default definitions may be superset by individual definitions. The default assignments primarily concerns properties such as background/foreground color, fonts, optical appearance, . . . and more specifically a mapping of the logical widget elements type to a concrete implementation such as the mapping to the JAVA implementation classes described above.

The widget document type definition (DTD) is maintained and in the responsibility of the developers of XGF core implementation since changes or modifications on the widget document type definition (DTD) affects the parsing operation and therefore the corresponding parsing function embodied in FIG. 2 as widget factory. New components as new widgets of the employed graphical user interface (GUI) or new properties (attributes) of widgets entail a modification of the widget document type description (DTD). The maintenance of the widget configuration is in the responsibility of both core developers and GUI developers.

Common explanations with respect to document type descriptions and XML-encoded configurations being based on the document type descriptions given with reference to FIG. 3a and FIG. 3b apply analogously to the following description referring to FIG. 4a and FIG. 4b.

FIG. 4a shows a clear text coding of an example screen document is type description, which includes type declarations with reference to screens according to an embodiment of the invention.

The presented screen document type definition (DTD) specifies additional element type declarations and one or more attributes assigned to a corresponding element type declaration and amplifies element type declarations, which are introduced with reference to the widget document type description shown in FIG. 3a, by additional attribute type declarations.

In line 2 an element “screen” is defined and the element type declaration specifies that the element “screen” comprises a element “panel” (cf. line 2: “panel”) to be arranged hierarchically subordinated. The element type “screen” has further assigned an attribute type declaration which includes an attribute “name” (cf. line 4), which is specified to contain character-encoded data content and to be compulsory, and an attribute “class” (cf. line 5), which is specified to contain character-encoded data content and to be obligatory.

In line 7 the element “panel” is defined and the element type declaration specifies that the element “panel” may comprise one or more elements out of the group of elements “gridlayout”, “panel”, “label”, “textbox”, “button”, “listbox”, “table” and “tree”. The element type “panel” has further assigned an attribute type declaration, which includes an attribute “name” (cf. line 9), which is specified to contain character-encoded data content and to be obligatory.

In lines 11, 17 and 25 are denoted a selection of element type declarations. The depicted screen document type description is not complete but the depicted screen document type description is an excerpt thereof such that only an example selection of example element type declarations are denoted.

For example reference should be given to the element type declaration of the element “button” denoted in the lines 25 to 32. The element “button” is amplified with an attribute type declaration comprising attributes “dataobject”, “attribute”, “name”, “listener” and “layoutmanager”. The attributes “dataobject”, “attribute” and “name” are defined as obligatory and are specified to contain character-encoded data content. The attributes “listener” and “layoutmanager” are specifies as compulsory, wherein the attribute “listener” is specified to have a value out of the group “ChangeListener” and “FocusListener” and the attribute “layoutmanager” is specified to contain character-encoded data content.

The additional attributes of this attribute type declaration relate to the screen functionality. This is, the attribute “dataobject” allows for associating the element “button” and a widget “button”, which is based on the element definition, with a certain determined data object, respectively. The attribute “name” allows for assigning an identification of the widget “button”. The attribute “listener” relates to the handling of user initiated events, i.e. user input which is to be interpreted as instruction, onto which a certain code section is to be processed. An event may include a click by a mouse on a “button” widget, an entering of text into a text accepting widget such as “textbox” widget and the like. The denotation listener is JAVA programming language specific but other programming languages supporting graphical user interface generation also provides similar event handlers. Without going into details of JAVA specifications, in case such an event is detected, a corresponding notification is generated and received by the event handler specified by the attribute “listener”. The implementation of events is essentially a typical callback system.

In contrast to currently discussed attribute type declaration it shall be noted that the attribute type declaration of the element “button” in the widget document type description (DTD) relates to the appearance of a widget “button” requested from the defined pattern.

The description given above applies also in an analogous way to the elements “textbox” and “label” denoted in lines 17 to 24 and 11 to 16, which are not discussed in detail.

FIG. 4b shows a clear text coding of an example screen configuration on the basis of the screen document type description shown in FIG. 4a according to an embodiment of the invention. In accordance with the screen document type description (DTD) (cf. FIG. 4a and description) the example screen configuration defines a determined example screen, which is embodied in FIG. 4c to support the aforementioned description. Therefore, the following description with reference to FIG. 4b is completed with references to FIG. 4c.

The example screen definition shows in exemplary way the hierarchical structure determined by the document type descriptions. An element “screen” defined in line 3 and designated with the name “Sample Screen” includes subordinated an element “panel” which again includes subordinated further elements and widgets, respectively. The element “panel” corresponds to the widget 10 in FIG. 4c, which represents an area, onto which the further widgets are arranged. In line 5 the arrangement of the widgets on the panel is defined. Two elements “label” are defined in lines 6 and 9, which corresponding widgets 11 and 14 of the widget type “label” are depicted in FIG. 4c. Further, the definition of the element “textbox” in line 7 leads to the widget 12 (cf. FIG. 4c), the definition of the element “button” in line 8 leads to the widget 13 (cf. FIG. 4c) and the element “listbox” in line 9 leads to the widget 14 (cf. FIG. 4c).

In accordance with the widget configuration (cf. FIG. 3b), on which the depicted widgets are based, the “label” widgets and the labels contained thereby are embodied as “TimesRoman” font, respectively. Correspondingly, the “textbox” and “listbox” widgets and the content contained thereby are embodied as “Arial” font. This aspect relates to the default configuration of the widgets.

The definition in line 8 specifies an element “button” which corresponds to the widget 13 (cf. FIG. 4c). The definitions in lines 11 to 15 specify a second element “panel” included subordinated in the previous element “panel” and the second element “panel” comprises hierarchically subordinated two elements “button”. The corresponding widgets are indicated as widget 16 (cf. FIG. 4c) referring to the second element “panel”, widget 17 (cf. FIG. 4c) corresponding to the element “button” in line 13 and widget 18 (cf. FIG. 4c) referring to the element “button” in line 14.

The elements, which corresponds to widgets accepting user events, i.e. which accept data input (“textbox” widget 12) or which allows for user operation such as “listbox” widget 15 (cf. FIG. 4c), “button” widgets 13, 17 and 18 (cf. FIG. 4c) include specifications of the data object and a corresponding listener, which is effected by the user event and which mediates and processes the user event, respectively.

Conclusively, it shall be understood that the screen document type definition (DTD) specifies the elements (entities), on the basis of which concrete screen implementation and designs are carried out, respectively. The totally supported and available grammatical elements (entities) of screen configurations are defined, which are coded as XML files. In analogy to the widget document type definition (DTD) the screen document type definition (DTD) is maintained by the core developers, since changes or modifications concern the parsing function, which is embodied as the screen factory referred to in FIG. 2.

The screen configurations specifying distinct screens of the graphical user interface (GUI), which is operable with the client application for displaying and modifying data of data objects, defines widgets, their hierarchy and the mapping of the widgets to the data objects. Further, the screen configuration defines the mapping of events occurring in conjunction with user inputs to the widgets of the screen to event targets and listeners to handle the events correspondingly. Moreover, the screen configuration associates the logical widget definitions with implementation classes of the JAVA programming language. The implementation classes of the JAVA programming language are to be understood as exemplary. Various corresponding implementation classes may be used. The implementation of the screen configuration further enables to provide further specific logic, for example for implementing a checking of user input. The search button 13 shown in FIG. 4c is operable with a mouse click to initiate a corresponding event. In a first operation in consequence on the initiated event an inserted logic may allow for checking whether an input in the textbox widget 12 exists and is valid such that further operation may be denied in case the input in the textbox 12 is not valid or nor present. The screen configurations are in the responsibility of the GUI developers.

The association of widgets and data objects and as a result the interacting on events originating from actions on data objects and widgets, respectively, will be more apparent with reference to the FIG. 5a and FIG. 5b.

FIG. 5a illustrates a schematic diagram, which illustrates the binding of data objects and widgets according to an embodiment of the invention. A screen widget container 400 shall logically comprise a set of widgets, which are exemplary depicted by widget 410. A data object container 450 shall logically comprises a set of data objects, which are exemplary depicted by data object (DObj) 460. A linking component 430 mediates between the widgets of the screen widget container 400 and the data object container 450.

In addition to the operational sequence according to an embodiment of the present invention and described with reference to FIG. 1b the widgets included in the dynamically created screen are linked with a data object (e.g. data object 460), which is placed in the data object container 450 such that a binding between graphical user interface (GUI), which implements the viewer layer application part, and the controller layer application part is established to enable a displaying of the data object. The data object shall be understood as a logical collection of fields, which include data content. The data content may be mapped to individual widgets or may be supported and expressed in widgets such as tableboxes, listboxes and the like such that the data content is displayable to the user and/or modifiable by the user.

The linking component 430 responsible for the linking/binding of data objects and widgets is further involved in a notifying for changes relating to the data objects. That means, in case a change affecting a data object (such as data object 460) occurs the data object container 450 or the data object affected by the change notifies in an operation S400 the linking component (binding component) 430 about the change and the linking component 430 mediates in an operation S410 this notification to the corresponding one or more widgets which are affected by the change. The mediating may comprise a finding operation, which allows the linking component 430 for identifying the affected widgets such as widget 410.

FIG. 5b illustrates a schematic diagram that depicts the logical linkage of components interacting with each other on handling a data object change notification according to an embodiment of the invention.

The schematic diagram illustrates schematic entities, which relates to components, code sections and elements involved in the data object displaying and handling, respectively. A certain determined screen, which comprises a widget, may be presented by the graphical user interface to a user. In FIG. 5b, this screen is depicted as screen instance 500, whereas the widget is depicted as widget 410. It may be further assumed that the widget 410 is a “listbox” widget, which allows for displaying a set of fields arranged in a list. Moreover, the “listbox” widget 410 may be employed to display a list of contracts that are associated with a certain deal. The data object (DObj) 460 may represent the deal, whereas the list of contracts may be represented by the data object (DObj) 465.

Assuming furthermore, that the user of the graphical user interface wants to change the displayed deal and has initiated a corresponding event. With view to FIG. 4c, the user may have inputted a new account number into the “textbox” widget 12, which identifies the aforementioned deal, and may have selected the search “button” widget 13, which has initiated a corresponding event passed on to the listener defined in the screen configuration (cf. line 8).

The “listbox” widget 410, which displays the contracts associated with the inputted account number of the deal has to be updated. The event initiated by the selection of the search “button” widget 13 is passed to the screen and screen instance 500, respectively, which is defined as “target” of events (cf. line 8 in FIG. 4b). The screen instance 500 delegates the event to its screen base class 510, such as defined in line 3 depicted in FIG. 4b. On receiving the select event, the screen base class 510 requests the data object loading component 600 for a new data object in accordance with the user input inputted in the “textbox” widget 12 and the data object loading component 600 places the corresponding new data object in the data object container 450. Now, the operational sequence follows the operational sequence illustrated in FIG. 5a. The data object container 450 indicates to the screen base class 510 that a new data object is present. On receiving of the notification that a change has occurred on the data object in the data object container 450, the screen base class 510 may invalidate the graphical user interface (GUI) and force a refreshing (repainting, updating) of the “listbox” widget 410 such that the data (i.e. the list of contracts) of the new data object is displayed by the graphical user interface (GUI) to the user.

The schematic diagram depicted in FIG. 5b illustrates additionally relationships between the components discussed above. The illustrated relationship is based on a unified modeling language (UML) denotation, which is employed for depicting and denoting complex dependency structures. The screen instance 500 is a member of the screen base class 510 acting as superordinate screen class. The data objects 460 and 465 are indicated as data objects being part of an aggregation of data objects which all belong to the superordinate data object container 450. The data object container 450 is again a member of the superordinated screen base class 510. A data object listener 610 and 620 is associated with the corresponding data objects 640 and 465, respectively. Moreover, the data object listeners 610 and 620 are linked (associated) to the screen base class 510 and each data object listeners is linked to a corresponding widget for receiving events. Herein, the data object listener 620, which is associated with the data object 465 representing the list of contracts, is linked with the widget 410, which shall represents the “listbox” widget for displaying the list of contracts such as “listbox” widget 15. Furthermore, the class instance 500 is also linked to each widget included in the class instance 500, which is exemplary illustrated in conjunction with widget 410. Finally, the data object loading component 600 is associated with the screen instance for operating.

It shall be noted that the description of the widget pattern generation has been illustrated in view of an initial process which results in a static providing of widget patterns by a widget pattern repository, on the basis of which widgets to be included into a screen for being displayed by the graphical user interface (GUI) are derived (requested and cloned, respectively). Alternatively, the widget patterns, which are required for deriving the widgets to be included in the screen, may be also created dynamically. That is, the request for a certain predetermined widget issued by the screen factory 240 instructs the widget factory 230 to dynamically create a corresponding widget pattern, on the basis of which the requested widget is generated preferably by the widget factory 230 but also instead of this by the screen factory 240. The corresponding widget pattern is created on demand, which eliminates the necessity of a widget pattern repository 210. The creating on demand further may require a identifying operation, which is preferably operated by the widget factory 230 and which allows for identifying this part of the complete widget configuration 310, which relates to the widget pattern definition, which corresponds to the requested widget. The widget pattern repository and widget cache 210 speeds up the screen creating process, respectively, such that implementation is advantageous.

It shall be noted that the components included in the presented terminal device performing functions and operations according to an embodiment of the invention may be constituted by a data processing device which may be comprised by the terminal device. Further, the components may be constituted by code sections for executing on one or a plurality of data processing devices containing instructions for carrying out the necessary processing operations for performing functions and operations. The functions or operations are exemplary presented with respect to the aforementioned methods according to embodiments of the invention. The operational sequences shall represent operations, which may be carried out by one or more dedicated components, which are preferably code sections containing instructions to allow for operation correspondingly. Alternative composition of components and a association of operations to different components is possible without departing the scope of the invention. It will be obvious for those skilled in the art that as the technology advances, the inventive concept can be implemented in a broad number of ways. The invention and its embodiments are thus not limited to the examples described above but may vary within the scope of the claims.

1. Method for generating a user interface of a network node, whereas an application is structured into a core application part responsible for handling data objects and a viewer/controller application part responsible for displaying said data and initiating actions on said data, wherein said viewer/controller application part is formed by said user interface, characterized
in that a screen mask creating module (240) for creating dynamically a screen mask of said user interface retrieves screen mask configuration data (320) and widget configuration data (310) over a network which are stored on a central processing unit,
in that a widget creating module (230) generates at least one user interface component (10-18; 410) on the basis of one or more component patterns (411, 412) of the widget configuration data (310) and stores the at least one user interface component (10-18; 410) by means of a widget cache (210),
in that a screen mask of said user interface is generated by said screen mask creating module (240), wherein said screen mask comprises at least one component which is a component out of said components comprising the widget configuration data, and
in that said at least one component of said created screen mask is assigned to at least one data object and/or dynamic of said components assigned to said screen mask based upon a user action on a user interface component and/or a data object.

2. Method according to claim 1, characterized in that said screen mask of said user interface is dynamically generated by said screen mask creating module (240).

3. Method according to claim 1, characterized in that said screen mask configuration data and/or widget configuration data are at least partially changed dynamically based upon one or more user actions.

4. Method according to claim 1, characterized in that said screen mask configuration data (320) is retrieved (S220), said screen mask configuration data (320) is parsed (S220) to obtain type information about said at least one component (10-18; 410) and to obtain individual settings of said at least one component (10-18; 410), said at least one component (10-18; 410) is created (S230) by obtaining (S231) said at least one component (10-18; 410) on the basis of at least one component pattern (411, 412) corresponding to said type information and said individual settings is applied (S232) onto said at least one component (10-18; 410) and including said at least one component (10-18; 410) into said screen mask.

5. Method according to claim 4, characterized in that said at least one component (10-18; 410) are requested from a component pattern repository (210), which caches at least one component pattern (411, 412), said at least one component pattern (411, 412) are identified corresponding to said type information, and said at least one component (10-18; 410) are derived from said at least one identified component pattern (411, 412).

6. Method according to claim 5, characterized in that said component pattern repository (210) is initialized by retrieving (S110) said widget configuration data (310), which comprises widget configuration data about at least one component pattern (411, 412), parsing (S120) said widget configuration data (310), creating (S130) said at least one component pattern, and storing said at least one component pattern in said component pattern repository (210).

7. Method according to claim 5, characterized in that said component pattern repository (210) contains statically said at least one component pattern (41.1, 412) during runtime of said application.

8. Method according to claim 1, characterized in that said at least one component (10-18; 410) are obtained by requesting said at least one component (10-18; 410), retrieving (S110) a widget configuration data (310), which comprises widget configuration data about at least one component pattern (411, 412), identifying said widget configuration data about said at least one component pattern (411, 412) corresponding to said extracted type information, parsing (S120) said identified widget configuration information, creating (S130) said at least one component pattern, deriving said at least one component (10-18; 410) from said at least one component pattern (411, 412).

9. Method according to claim 1, characterized in that said at least one component (10-18; 410) are obtained by cloning said at least one component pattern (411, 412) to obtain said at least one component (10-18; 410).

10. Method according to claim 1, characterized in that said widget configuration data (310) comprises default widget configuration information about said at least one component pattern (411, 412) such that components (10-18; 410) obtained from said least one component pattern (411, 412) have default settings valid for substantially all components used in the user interface.

11. Method according to claim 1, characterized in that said screen mask configuration data (320) comprises screen mask configuration data about at least one component (10-18; 410) to adapt said component (10-18; 410), which is obtained from said corresponding component pattern (411, 412), to requirements presupposed by said screen mask to be created.

12. Method according to claim 1, characterized in that said screen mask configuration data (320) is an XML-encoded screen mask configuration data, which is based on a screen mask document type description (DTD; 340).

13. Method according to claim 1, characterized in that said widget configuration (310) is an XML-encoded widget configuration, which is based on a widget document type description (DTD; 330).

14. Software tool for establishing a user interface (GUI), comprising program portions for carrying out the operations of claim 1, when said program is implemented in a computer program for being executed on a microprocessor-based device, processing device, a terminal device or a network device.

15. Computer program product for establishing a user interface (GUI), comprising loadable program code sections for carrying out the operations of claim 1, when said program code is executed on a microprocessor-based device, processing device, a terminal device or a network device.

16. Computer program product for establishing a user interface, wherein said computer program product comprises program code sections stored on a computer readable medium for carrying out the method of claim 1, when said computer program product is executed on a microprocessor-based device, processing device, a terminal device or a network device.

17. Terminal device adapted to establish a user interface, which is operable by a user to operate an application executed by said terminal device, which comprises a screen mask creating component (240) for creating dynamically a screen mask of said user interface (GUI), comprising:
a retrieval component (260, 270) for retrieving a screen mask configuration data (320) and widget configuration data (310), which comprises configuration data about at least one component (10-18; 410),
a parsing component (250, 230, 240) for parsing said screen mask configuration data (320) to obtain type information about said at least one component (10-18; 410) and to obtain individual settings of said at least one component (10-18; 410), and for parsing said widget configuration data (310) to obtain one or more component patterns (411, 412),
a widget creating component (230) for obtaining said at least one component (10-18; 410) on the basis of at least one component pattern (411, 412) corresponding to said type information and for applying said individual settings onto said at least one component (10-18; 410), and
a linking component (430) for linking said at least one component (10-18; 410) to at least one data object (460, 465).

18. Terminal device according to claim 17, comprising a component pattern repository (210) which caches at least one component pattern (411, 412) and from which at least one component (10-18; 410) is requested and an identification component (240) for identifying at least one component pattern (411, 412) corresponding to said extracted type information, wherein said widget creating component (240) is adapted to derive at least one component (10-18; 410) from said at least one identified component pattern (411, 412).

19. Terminal device according to claim 17, wherein said terminal device comprises as further components for initialization of said component pattern repository (210) a retrieval component (260, 270) for retrieving a component configuration (310), which comprises component configuration data about at least one component pattern (411, 412), and a parsing component (250, 230) for parsing said component configuration information, wherein said widget creating component (230) is adapted to create said at least one component pattern (411, 412) and to store said at least one created component pattern (411, 412) in said component pattern repository (210).

20. Terminal device according to claim 19, comprising a retrieval component (260, 270) for retrieving a component configuration (310), which comprises component configuration information about at least one component pattern (411, 412), an identification component (240) for identifying said component configuration information about said at least one component pattern (411, 412) corresponding to said extracted type information, and a parsing component (250, 230) for parsing said identified component configuration information, wherein said widget creating component (230) is adapted to create said at least one component pattern (411, 412) and to derive said at least one component (10-18, 510) from said at least one component pattern (411, 412).
